(19) United States
(12) Patent Application Publication
(10) Pub. No.: US 2002/0059174 A1
(43) Pub. Date: May 16, 2002

(54) System and method for sharing bottles of wine

(76) Inventor: Ehud Shapiro, New York, NY (US)

Correspondence Address: HALE & DORR LLP, THE WILLARD OFFICE BUILDING, 1455 PENNSYLVANIA AVE, NW, WASHINGTON, DC, 20004, US

(21) Appl. No.: 09/901,567

(22) Filed: Jul. 11, 2001

Related U.S. Application Data
(60) Provisional application No. 60/217,029, filed on Jul. 11, 2000.

(51) Int. Cl. G06F 7/00

(52) U.S. Cl. 707/1

(57) ABSTRACT

The present invention is a computer-implemented and/or assisted method for sharing, for example, bottles of wine. The computer system allows customers to request a glass or taste of wine, and when the requests reach a predetermined threshold for a given bottle of wine, the bottle of wine is uncorked and served. Requests can be made from within the establishment or from a remote location prior to entering the establishment. The invention allows customers to indulge in a glass or taste of wine not usually available in that amount at most establishments. Other itmes may alternatively be shared.

### BACKGROUND OF THE INVENTION

1. Field of Invention

The present invention relates to a system and computer-implemented and/or assisted method for sharing bottles of wine, beverages and/or other consumer, items including perishable or nonperishable foods and/or other items of purchase or use. The present invention more particularly relates to a method and system in which, for example, a bottle of wine can be opened while ensuring most if not all of the bottle will be consumed. The computer-implemented and/or assisted method allows customers to request a glass or taste of, for example, a particular unusual select or rare wine at either the same establishment or several establishments and subsequently, if enough people request the wine, the bottle will be uncorked, served in part to a plurality of customers, and substantially consumed without necessarily having to preserve the remaining contents. The present invention optionally applies to various beverages, foodstuffs or other articles for purchase or use. For example, a similar example applies to soufflés in a restaurant, where various patrons from different tables can share the dessert. The present invention optionally applies to reward systems or social gatherings where no specific purchase is necessary.

2. Background of the Related Art

Wine bottles need to be consumed within a short period after being uncorked, or else the wine loses its special qualities or flavor. Hence, patrons of a restaurant or bar are faced with the choice of either purchasing a whole bottle of wine from the entire selection in the restaurant, or ordering wine by the glass from a limited selection. Wine tasting is typically not available at restaurants or bars and is restricted to special events with predefined selections. Wine owners who wish to open a rare bottle typically need to make special arrangements to justify the event, even if all they wish is to taste the wine or drink a glass of it.

An unfinished open bottle of wine has always posed the problem of how to preserve its contents. Over time the quality of the wine deteriorates as it continues to be exposed to the air. Several different apparatus have been developed to close or re-seal an uncorked bottle of wine. Stoppers for closing uncorked bottles of wine and sparkling ciders are known. There are currently several different types of stoppers to help prevent deterioration in the wine over time. These apparatuses, however, cannot maintain the original quality of the wine over a long period, and therefore, the wine loses its appeal for consumption. FIGS. 1-2 depict two examples of stoppers available.

FIG. 1 is a side view of the stopper, in U.S. Pat. No. 6,213,323, incorporated herein by reference. In FIG. 1, the stopper comprises firstly a hollow cylindrical body 2, which has a longitudinal axis and is designed to be inserted into the neck of the bottle 1 substantially coaxial therewith. The hollow cylindrical body 2 has a base 2a with a whole housing a support 4 for a seal. Each of the shaped incisions 2b receives inside it a tongue 8, which is inclined with respect to the longitudinal axis 3 and fixed to the hollow cylindrical body 2 by means of joints 9. The tongues 8 and the joints 9 may be made of plastic molded as one piece. Moreover, the tongues 8 may rotate about the joints 9 and are intended to be inserted underneath the lip of the bottle.

The securing means comprise the cap 7 of the hollow cylindrical body 2 which is formed as a cylindrical structure with a base 7a having radial dimensions slightly greater than the hollow cylindrical body 2 and side surface 7b comprising two extensions 7c which are arranged in diametrically opposite positions corresponding to the tongues 8. The cap 7 is mounted on the hollow cylindrical body 2 and is slideable with respect thereto along the longitudinal axis 3.

During positioning of the cap on the bottle, is it sufficient to insert the hollow cylindrical body 2 on the neck of the bottle and press the cap 7 so as to lock the tongues 8 underneath the lip. The securing means 10 ensure a more reliable and constant locking action, over time, of the tongues 8.

In fact, pressing the cap causes relative sliding of the cap with respect to the hollow cylindrical body 2 until the locating shoulder engages underneath the upper edge 2c of the shaped incisions 2b. In this way the extensions 7c of the cap 7 are positioned on the tongues 8, keeping them pressed underneath the lip.

FIG. 2 is an exploded view of a container used to preserve the characteristics of the beverage contained therein, in U.S. Pat. No. 6,105,803 incorporated herein by reference. In FIG. 2, container 20 includes cap 26, inner cylindrical member 22 and outer cylindrical member 24. Tube 36 is shown in dashed outline. Near its lower end, member 22 has a slightly increased diameter accommodating a grove into which is placed an O-ring seal 40. External threads 28 threadedly engaged with the internal threads formed on the inside of the surface of the outer cylindrical member 24.

Currently there are systems which process requests for orders within a restaurant. The restaurant management system allows for orders/requests to be entered into a terminal within the restaurant, including orders for beverages or fine wines. The restaurant management system architecture includes a database of the inventory along with a supplier such as a waiter and a user, e.g., the customer. The restaurant management system also includes a feature, which determines the appropriate delay before the food is delivered. In the event that the requested item is not served within the specified time frame, an alarm is triggered. A monitoring system also accompanies the restaurant management system, and the monitoring system displays a representation and the status of each customer.

FIG. 3 illustrates a block diagram of the operating system of the hospitality point of sale system 10, in U.S. Pat. No. 6,088,681 incorporated herein by reference. In FIG. 3, a systems manager 50 is provided. The systems manager 50 may receive input and send output. A user 52 is also provided. In this case, the user is associated with a table at the restaurant. A supplier 54 is also provided. The supplier 54 in this case is a kitchen where food is prepared in a restaurant. The user 52 is connected to the supplier 54 by an order path 56 and a product path 58. Orders from the user 52 are sent through the order path 56 to the supplier 54. Once product is prepared by the supplier 54, it is sent through the product path 58 to the user 52. A bank 60 is also provided. The bank 60 is connected to the user 52 through one-way payment path 62, which flows through the user 60 to the bank 62. An inventory 64 is also provided. Raw materials flow from the inventory 64 to the supplier 54, as needed. An inventory database 66 is provided and is connected to the supplier 54 to receive information from the supplier 54 about inventory used and replaced. The systems manager 50 is connected to the user 52 through a user input 68, which flows one-way from the user 52 to the systems manager 50. The systems manager is connected to the supplier 54 by a one-way control output 70 and a one-way feedback input 72.

In operation, the user 52 places an order for a product. The order is sent from the user 52 to the supplier along the order path 56. Along with the order, time information is also sent. This time information states when an order was placed, how long the order was taken, how long the individual items that make up the order will take to prepare, and when the order may be delivered to the user 52. This information is also sent to the systems manager 50 along user input 68. The systems manager 50 then decides when preparation on the items of the order should be begun, when the order should be delivered, and what inventory 64 is needed to supply the order. The results of this analysis are sent along control output 70 to the supplier.

Supplier 54 then follows the instructions from the systems manager 50 and prepares the order. Systems manager 50 keeps track of the time at which the preparations of the order was begun, what items have been prepared and when the items are ready. This is done through feedback input 72. As the supplier 54 prepares the order, the inventory database 66 is updated to reflect the product used from the inventory 64. Once the time has elapsed for the order to have been prepared by the supplier 54, the product, which is in this case food, is delivered along the product path 58 at the given time. Once the user 52 has completed using the product, a payment is sent from the user 52 to the bank 60 along a payment path 62. Once the transaction is completed with the bank 60, the user 52 is finished.

Accordingly, there is a general need, as I have identified and determined as described herein to provide the capability for individuals to share various items, such as perishable food and beverages, whether in a social or commercial context.

### SUMMARY OF THE INVENTION

Wine bottles need to be consumed within a short period after being uncorked, or else the wine loses its special qualities. Hence patrons of a restaurant or bar are faced with the choice of either purchasing a whole bottle of wine with the feature of being able to select from the entire collection, or ordering wine by the glass from a very limited and oftentimes unstatisfactory collection. Further, wine tasting is typically not available at restaurants or bars and is restricted to special events with predefined selections. Wine owners who wish to open a rare bottle even in a social context typically need to make special arrangements to justify the event, even if all they wish is to taste the wine or drink a glass of it.

A feature and advantage of the present invention is in providing a computer system combined with a business process that alleviates the above problems. The system can be deployed in a restaurant or a bar, as well as connect to several such establishments that utilize it.

Another feature and advantage of the present invention is to enable customers to view available wines and make at least one request from a remote location.

Another feature and advantage of the present invention is to enable customers enter to payment information while the request is made.

Another feature and advantage of the present invention is to enable customers to check on the status of his/her request.

Another feature and advantage of the present invention is to enable customers to view specials or promotions on an electronic bulletin board.

Another feature and advantage of the present invention is to allow a customer to bring his/her personal wine to share or sell in the establishment.

Another feature and advantage of the present invention is to enable the establishment to contact customers with promotions, specials or other information.

Another feature and advantage of the present invention is to enable the establishment to determine whether the price per glass or taste of wine is flat fee or if it is sensitive to the length of time the bottle has been uncorked.

The system in accordance with one embodiment comprises a central computer that is connected to terminals that are available to the patrons, either directly, via waiters that operate them or through other means. The central computer maintains an inventory of available corked bottles of wine, uncorked bottles and the available amount of wine in each such bottle, time and date the bottle was uncorked and a set of requests from patrons to taste wine and/or drink wine by the glass. The level of interest in a corked bottle of wine is, for example, a weighted sum of the number of requests to taste it or to drink it by the glass, with each request type carrying a different weight reflecting the amount of wine each consumes. Other criteria for determining the level of interest and/or threshold may alternatively be used. Other hardware architectures/platforms may also be used.

The terminals provide a dynamically updated display of a current list of available bottles of wine, corked and uncorked, for uncorked bottles how much wine is available, and for corked the level of interest in the bottle as well as the price for a taste, a glass and/or a bottle. The establishment can optionally decide to determine the price of a taste or glass of wine sensitive to the length of time the bottle has been uncorked. The terminals also display the date and time the bottle was uncorked. The terminals allow the patrons to enter requests for tasting wine, for drinking wine by the glass, or for purchasing a bottle. When the level of interest in a corked bottle exceeds a certain threshold, to be determined from time to time by the owner, the bottle is opened and served to those who requested it. There is no requirement that the request be made in the establishment and/or that a single establishment performs the process. For example, establishments geographically near may pool together, and split the item or glass of wine.

In accordance with the present invention, the system includes a database, storing information which includes corked and uncorked wines, and available amounts of wine in each such bottle. A data entry device allows customers to request a glass, taste or bottle of wine. The data entry device may optionally be wireless. An optional communication device may be used by each establishment to monitor the requests for wine. A data processor is connected to the database, data entry device and optional communication device, wherein the data processor receives the wine request and determines whether the threshold has been met to uncork one bottle, and/or determines whether an already uncorked bottle will satisfy the request.

As new requests are entered, the requests are accumulated and added to the database. The data entry device, wireless device, global network and local network are dynamically updated with the new requests as they are made. The data entry device, wireless device, global network and a local network visually display the wine requests as the requests are incremented or decremented for a particular wine.

The database also may optionally include a bulletin board for promotions offered either by a vendor, the establishment or other persons. Customers have the ability to access the available wine database and bulletin from a remote location. The customer also has the ability to make multiple request or mutually exclusive requests. If the wine is not immediately available, customers may enter a waiting period for the threshold to be met. The establishment may provide customers with remote communication devices that notifies them either when the threshold has been met or the requested wine is uncorked.

The present invention allows for the establishment to determine whether the cost for a taste or glass wine is a flat fee, or if the price should be sensitive to how long the bottle has been uncorked. The variable price can be applied to customers who request wine after the threshold has been met and may act as an incentive to buy the uncorked wine.

The system described above can optionally include a database of customers. The database of customers is used to notify customers in advance of available wine and additional requests. The customers can also be notified with promotions and specials.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there is illustrated preferred embodiments of the invention.

### BRIEF DESCRIPTION OF THE DRAWINGS

FIG. 1 is a side view of a stopper;

FIG. 2 is an exploded view of a container;

FIG. 3 illustrates a block diagram of the operating system of the hospitality point of sale system;

FIG. 4 is a flow chart of the general process of entering a request for a glass or taste of wine from a terminal within an establishment;

FIG. 5 is a flow chart of mutually exclusive requests;

FIG. 6 is a flow chart of the process in which the customer preorders a glass, taste or bottle of wine from a remote location;

FIG. 7 is a flow chart of the process for customers to request and access wines from various establishments;

FIG. 8 is a flow chart of the process for requesting a wine currently not available;

FIG. 9 is a flow chart of the process in which a request is canceled;

FIG. 10 illustrates an example of a preorder form for several establishments;

FIG. 11 illustrates an example of the preorder form reply from the establishments for preorders submitted by the customers;

FIGS. 12A and 12B illustrates example screens displaying the wine requests;

FIG. 13 is an illustration of a main central processing unit that implements the computer processing in accordance with the computer-implemented for embodiment of the present invention;

FIG. 14 is a block diagram of the internal hardware of the computer 40 illustrated in FIG. 13;

FIG. 15 is a block diagram of the internal hardware of the computer in FIG. 13;

FIG. 16 is an illustration of the architecture of the combined internet, POTS, and DSL architecture of the present invention in accordance with another embodiment.

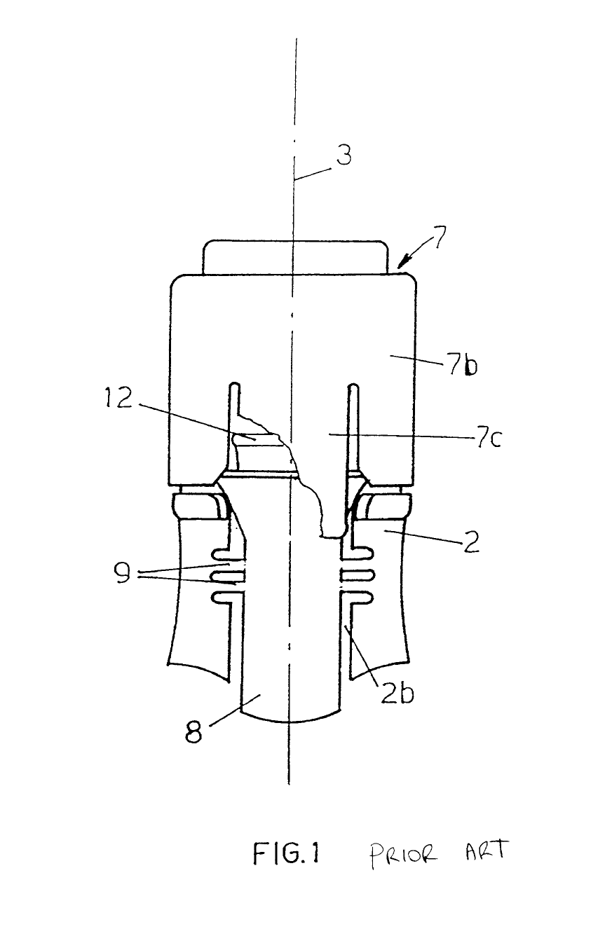

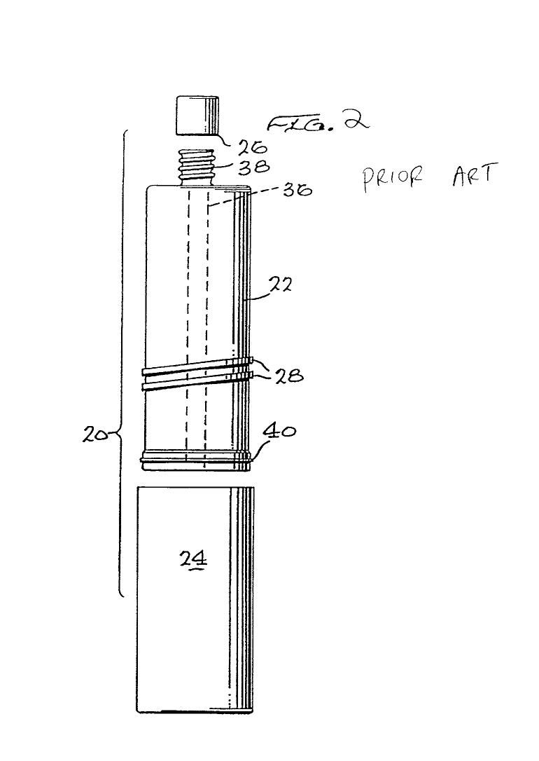

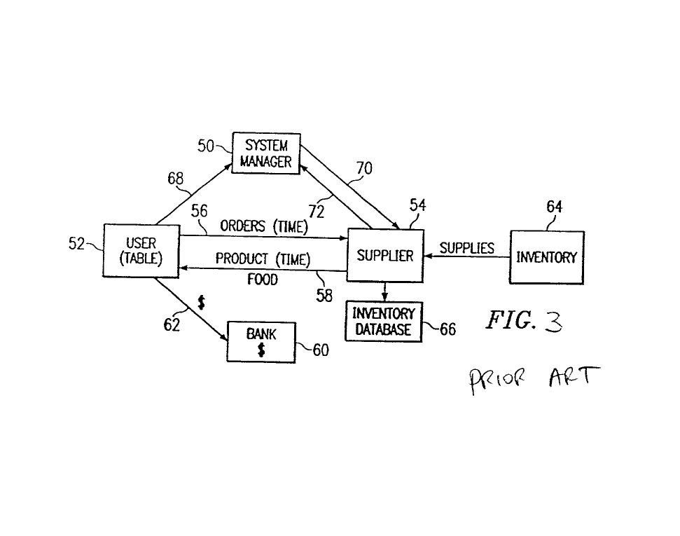

### NOTATIONS AND NOMENCLATURE

The detailed descriptions which follow may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

Best Mode for Carrying Out the Invention

Reference now will be made in detail to the presently preferred embodiments of the invention. Such embodiments are provided by way of explanation of the invention, which is not intended to be limited thereto. In fact, those of ordinary skill in the art may appreciate upon reading the present specification and viewing the present drawings that various modifications and variations can be made.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

The present invention relates to a method to ensure predetermined and/or substantial consumption of the contents an opened bottle of wine when a consumer does not desire an entire bottle. The invention includes a method of determining if there are enough patrons desiring a wine that is not generally sold by the glass, and is implemented by a computer system which is accessible, for example, at terminals available to the patrons, either directly or via waiters that operate them.

The system comprises a central computer that is connected to terminals that are available to the patrons, either directly through any standard connection including: the Internet, direct dial, wireless, in-person, or via waiters that operate them. The central computer maintains an inventory of available corked bottles of wine, uncorked bottles and the available amount of wine in each such bottle, time and date a bottle was uncorked and a set of requests from patrons to taste wine and/or drink wine by the glass. The level of interest in a corked bottle of wine is, for example, a weighted sum of the number of requests to taste it or to drink it by the glass, with each request type carrying a different weight reflecting the amount of wine each consumes. Other standard criteria for determining the level of interest and/or threshold may alternatively be used. Other hardware architectures/platforms may also be used.

The terminals within the establishment or other devices provide a dynamically updated display of a current list of available bottles of wine, corked and uncorked, for uncorked bottles how much wine is available, and for corked bottles the level of interest in the bottle. Optionally, the price for tasting, a glass and a bottle of the wine also provided. The establishment can optionally determine if the price per glass or taste is to remain constant or if the price after uncorking should be sensitive to how long the bottle has been open. FIGS. 12A and 12B illustrate example screens displaying the wine requests. The display can be shown on a terminal, wireless device, global network and/or local network. The screens depict the level of interest in corked bottles of wine and how much wine is available in uncorked bottles of wine. This display also includes date and time the bottle was uncorked and the price per glass or taste of wine. The display can be depicted both visually and numerically. The terminals allow the patrons to enter requests for tasting wine, for drinking wine by the glass, or for purchasing a bottle. When the level of interest in a corked bottle exceeds a certain threshold, to be determined, optionally from time to time, by the owner, the bottle is opened and served to those who requested it.

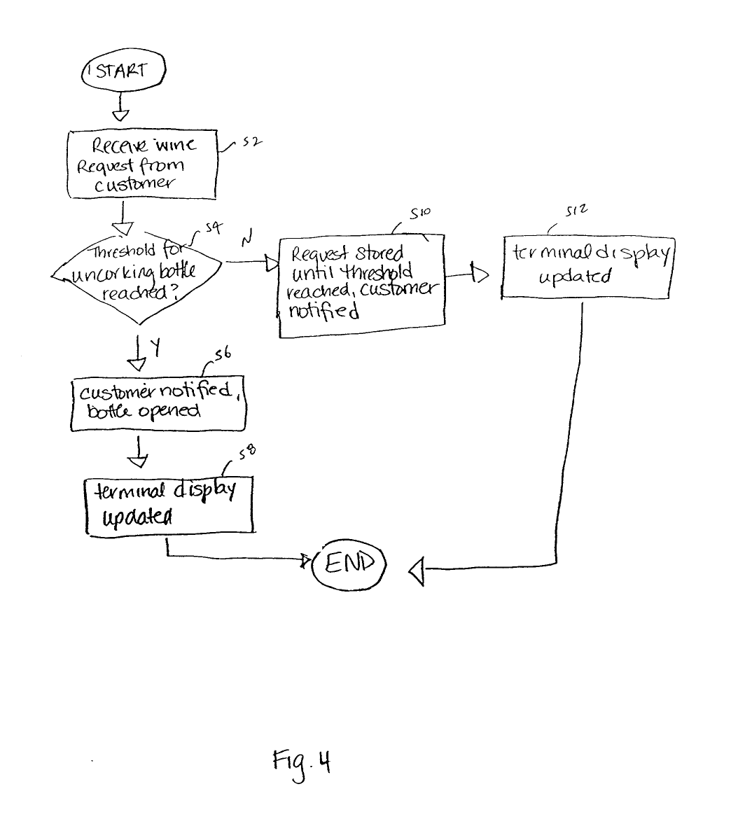

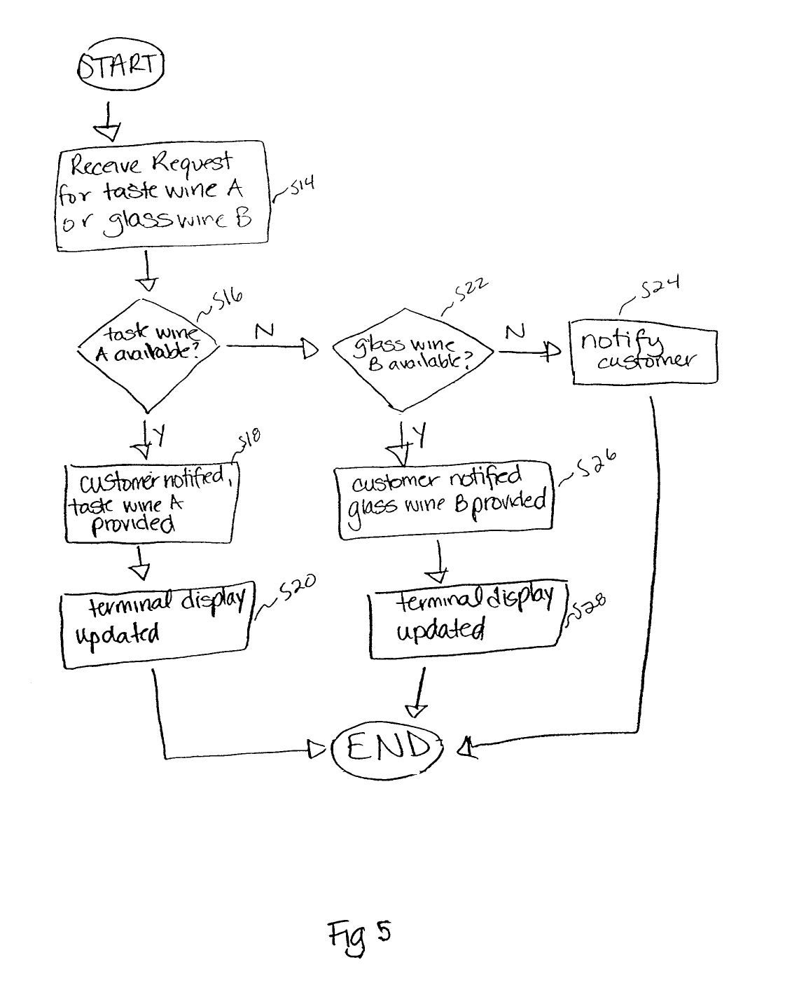

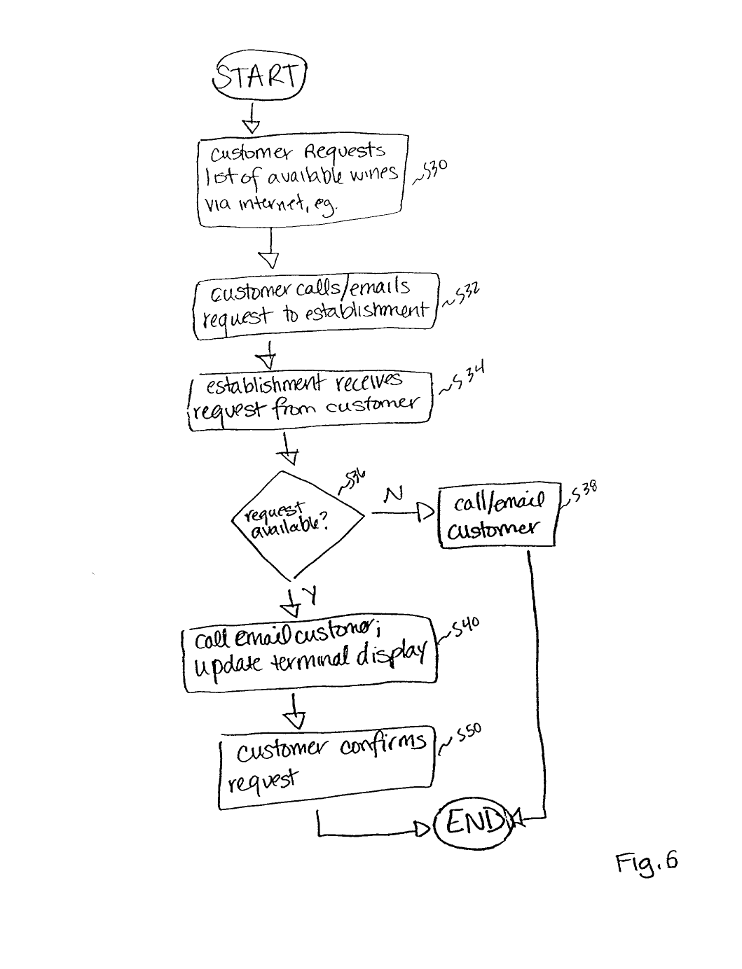

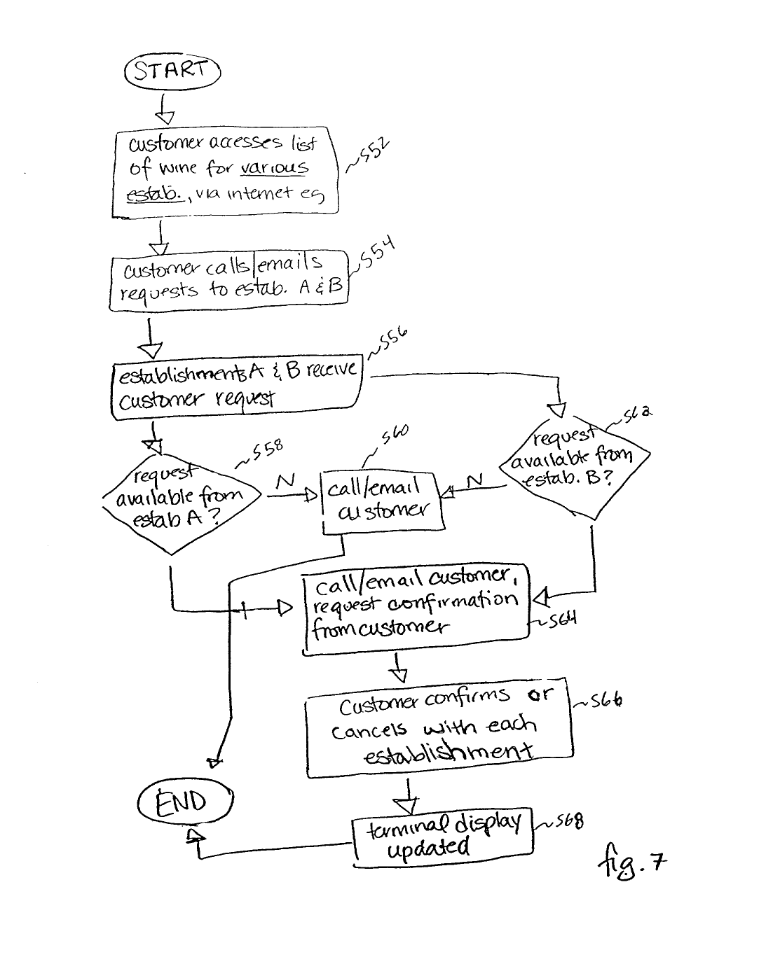

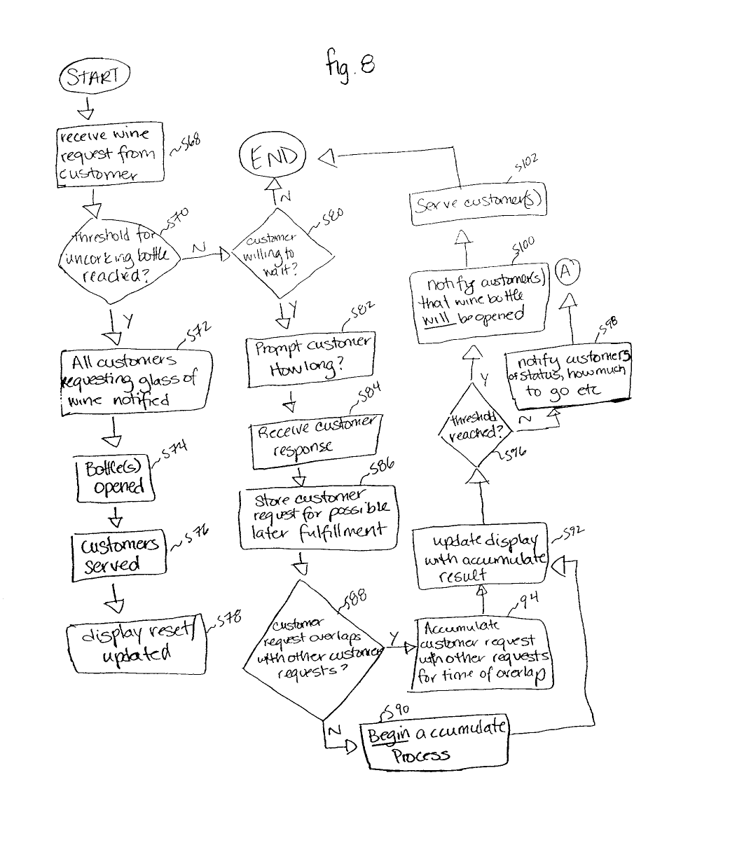

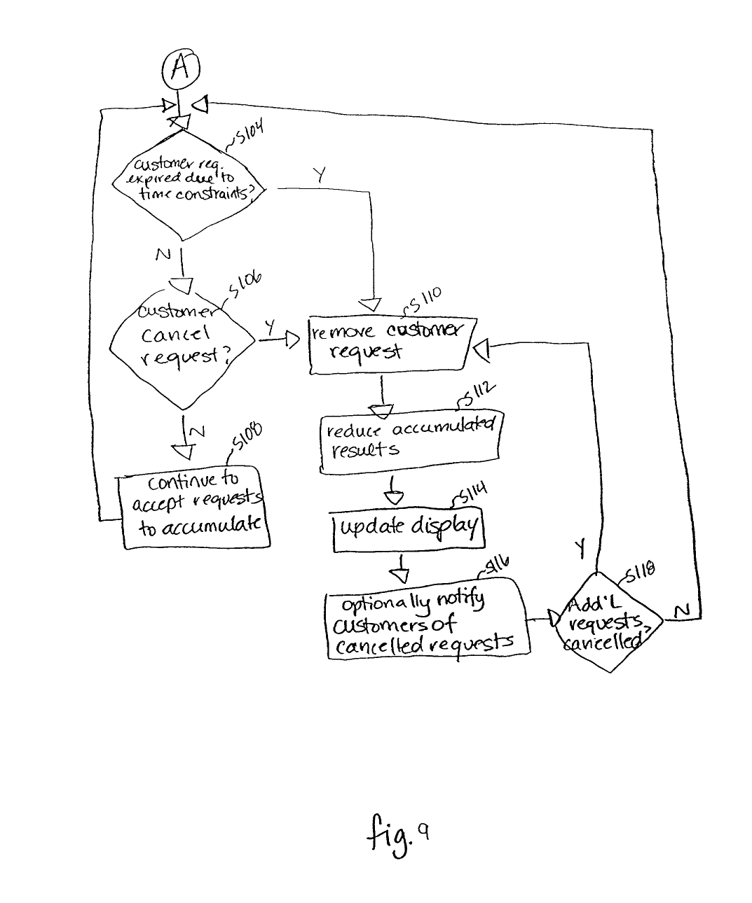

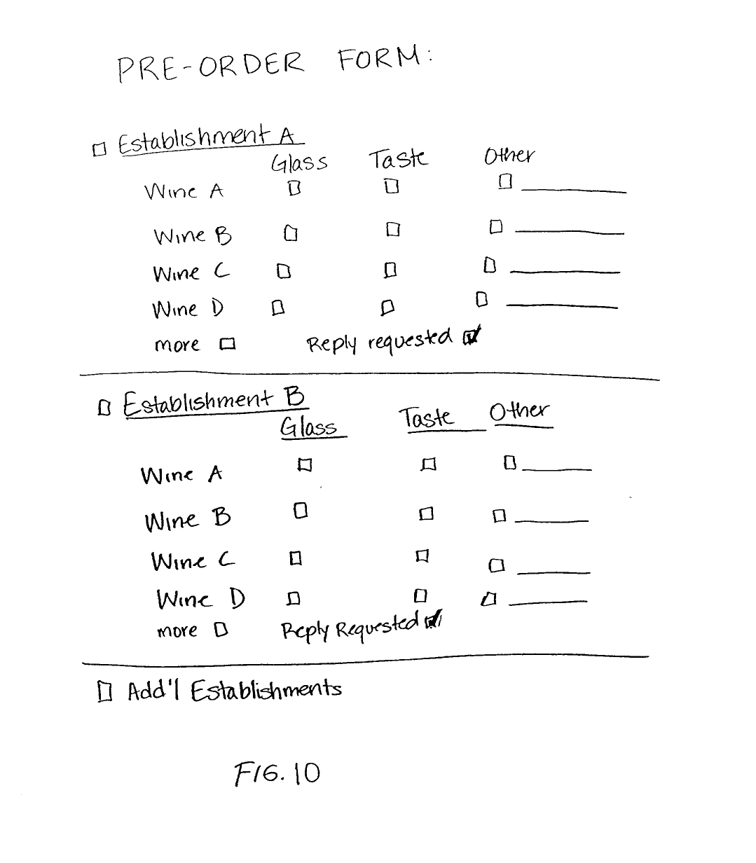

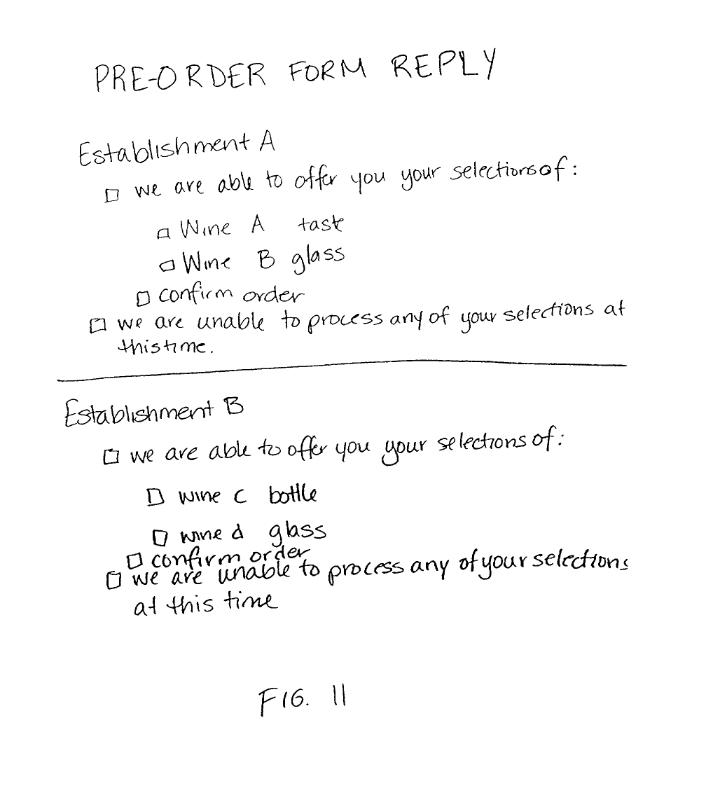

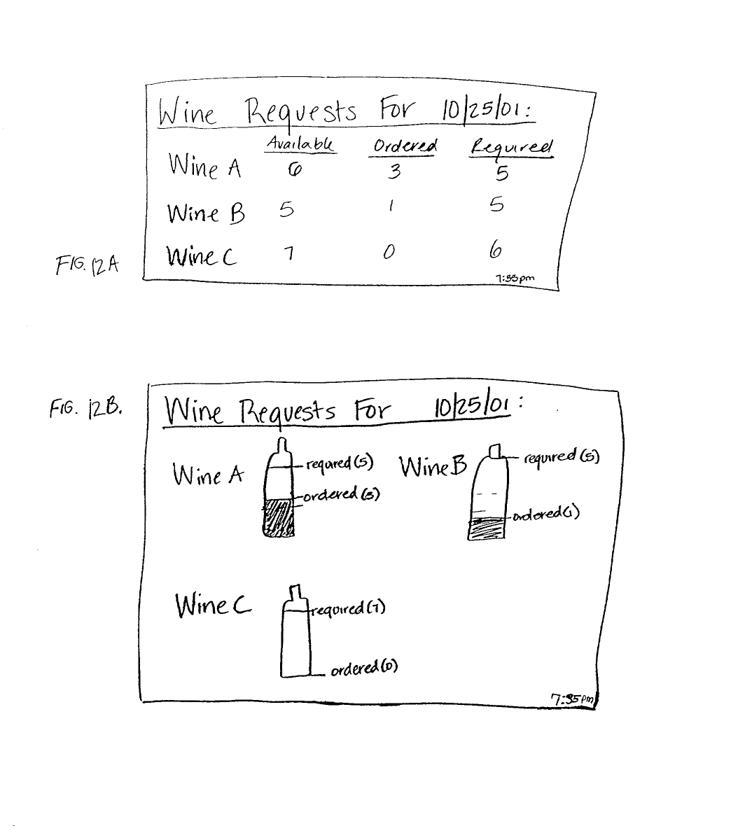

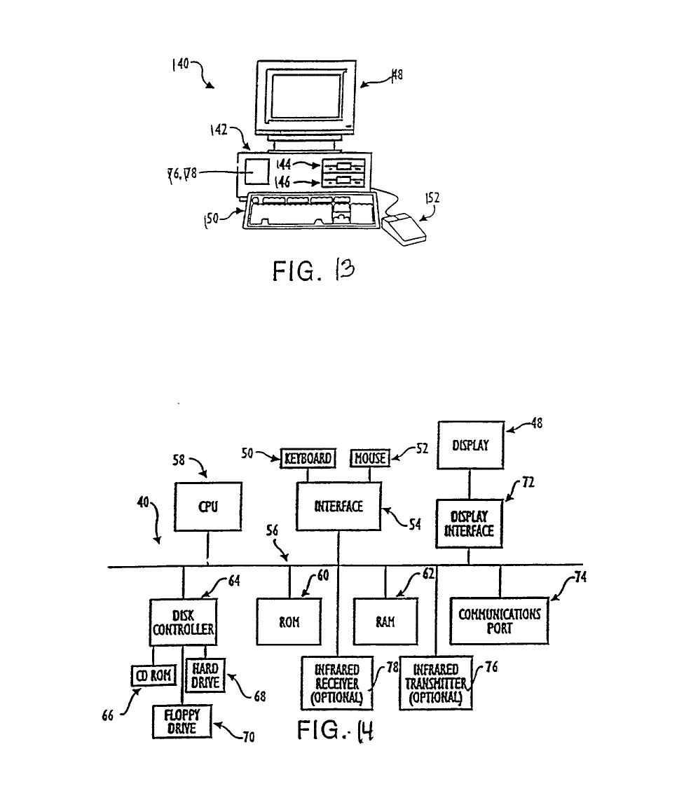

In accordance with one embodiment of the invention, customers have the ability to make a request for wine using the method described herein from either a remote location or from a terminal within the establishment itself. FIG. 4 is a flow chart of the general process of entering a request for a glass or taste of wine from a terminal within an establishment. In Step S2, the establishment receives a request for wine from a customer. The system then determines if the threshold for uncorking a requested bottle of wine has been met in Step S4. The uncorking threshold comprises, for example, a predetermined number of glasses or level of consumption of purchasers committing to purchase the glass or taste of wine. Alternatively, the threshold may be determined based on a number of people that are interested in consuming the beverage, or other criteria. In certain situations, all or a portion of the glasses/tastes available for a bottle of wine may be auctioned or sold publicly. If it is determined in Step S4 that the threshold has been met, in Step S6 the customers, who requested the wine, are notified, and the bottle of wine is opened and served. The customer, while in the establishment, can be notified over a loud speaker, by cell phone, pager or other mobile device. The mobile devices can either be a personal device or one provided by the establishment. In Step S8 the terminal display is updated.

If in Step S4 it is determined that the threshold has not been met, in Step S10 the request is stored until the threshold is met and the customer is notified of the delay. The terminal display is updated of this status in Step S12. The customer has either the option of entering his/her payment information as he/she makes the request for wine or the customer can pay when he/she receives the wine at the establishment. The present invention optionally allows for the establishment to determine whether the cost for a taste or glass wine is a flat fee, or if the price should be sensitive to how long the bottle has been uncorked. Advantageously, the customer may be notified using various method of progress of the interest in the wine, and the likelihood of the there being sufficient interest based on previous experience for example.

In accordance with another embodiment of the invention, customers have the ability to make multiple requests at once or to make mutually exclusive requests. FIG. 5 is a flow chart of mutually exclusive requests. In Step S14 a request is received from a customer for a taste of wine A or a glass of wine B. The customer has either the option of entering his/her payment information as he/she makes the request for wine or the customer can pay when he/she receives the wine at the establishment. The customer could alternatively enter several requests, which are not mutually exclusive. In Step S16, if it is determined the taste of wine A is available, the customer making the request is notified and taste of wine A is provided in Step S18. In Step S20 the terminal display is updated.

If it is determined in Step S16 the taste of wine A is not available, it is determined if a glass of wine B is available in Step S22. If it is determine in Step S22 that the glass of wine B is not available, the customer requesting the glass is notified in Step S25. If it is determined the glass of wine B is available in Step S22, the customer is notified and the glass of wine B is provided in Step S26. The customer, while in the establishment, can be notified over a loud speaker, by cell phone, pager or other mobile device. The mobile devices can either be a personal device or one provided by the establishment. The terminal display is updated of this status in Step S28.

In accordance with another embodiment of the invention, customers also have the option to order a glass, taste or bottle of wine before they reach, or remotely from, an establishment. This allows the customer to determine what wine will be available. If the customer desires a particular wine, he/she can make certain the establishment has the particular wine available before arriving.

FIG. 6 is a flow chart of the process in which the customer preorders a glass, taste or bottle of wine from a remote location. In Step S30, the customer reviews a list of available wines via the Internet or some other remote communication method such as by mobile phone. The customer calls or emails his/her request to the establishment in Step S32. The customer has either the option of entering his/her payment information as he/she makes the request for wine, or the customer can pay when he/she receives the wine at the establishment. In Step S34 the establishment receives the customer request and in Step S36 determines if the requested wine is available.

If it is determined the requested wine is not available in Step S36, the customer is called or emailed with the non-availability status in Step S38. If the request is available in Step S36, the customer is called or emailed to confirm the request and the terminal display is updated in Step S40. In Step S50 the customer confirms the request.

FIG. 10 illustrates an example of a preorder form to be sent to several establishments which can be used, for example, in the remote location request process as described above and shown in FIG. 6. More particularly, the preorder form is of a type that can optionally be displayed on a remote terminal screen used by the customer. FIG. 11 illustrates an example of the preorder form reply from the establishments for preorders submitted by the customers. More particularly, the preorder form reply is of a type that can be optionally displayed on a remote terminal screen used by the customer.

In accordance with another embodiment of the invention, as noted above, customers are able to request wine from several different establishments, usually using remote access to view the wine lists. FIG. 7 is a flow chart of the process for customers to request and access wines from various establishments. In Step S52 the customer accesses a list of wines available in various establishments from a remote location, such as via the Internet, wireless communication or some other remote communication method. The customer calls or emails his/her request to the various establishments, for example, establishment A and establishment B, in Step S54. In Step S56, establishments A and B receive the customer request. In Step S58, establishment A determines if the requested wine is available. If it is determined the requested wine is not available Step S58, the customer is called or emailed with the non-availability status in Step S60.

In Step S62, establishment B determines if the requested wine is available. If it is determined the requested wine is not available in Step S62, the customer is called or emailed with the non-availability status in Step S60. Steps S58 and S62 may occur coincidentally or consecutively within a brief period. If either or both requested wines in Steps S58 and S62 are available, the customer is emailed or called to confirm the requested wine in Step S64. In Step S66 the customer will either cancel or confirm with each establishment. For example, the customer could cancel both requests, cancel only one request or confirm both of the requests. In Step S68 the terminal display is updated of the status selected in Step S66. The customer has either the option of entering his/her payment information as he/she makes the request for wine or the customer can pay when he/she receives the wine at the establishment. Alternatively, the customer may not have the option of canceling an order, once the order has been placed.

In accordance with another embodiment of the invention, requested wine is not always immediately available because the threshold has not yet been met. The present invention allows for the customers to specify a time he/she is willing to wait for the requested wine. FIG. 8 is a flow chart of the process for requesting a wine currently not available. In Step S68 the wine request is received from the customer, and in Step S70 the threshold is checked. The uncorking threshold comprises, for example, a predetermined number of glasses or level of consumption of purchasers committing or interested in purchasing the glass or taste of wine. If it is determined in Step S70 that the threshold has been met, all customers requesting wine are notified in Step S72. The customer, for example, while in the establishment, can be notified over a loud speaker, by cell phone, pager or other mobile device. The mobile devices can either be a personal device or one provided by the establishment. In Step S74 the bottles are opened. The customers are served in Step S76, and in Step S78 the display is reset/updated. If it is determined the threshold has not been met in Step S70, the customer is prompted if he/she is willing to wait for the requested wine in Step S80. If it is determined the customer is willing to wait in Step S80, then in Step S82 the customer is prompted how long he/she is willing to wait for the requested wine.

In Step S84, the customer response is received, and in Step S86 the customer request is stored for later fulfillment. If it is determined in Step S88 the customer request does not overlap with another customer's request, the accumulation with the existing request begins in Step S90. If it is determined in Step S88 the requests do overlap, the overlapping requests are accumulated together in Step S94. After either Step S90 or Step S94, in Step S92 the terminal display is updated with the status of the results. In Step S96 the threshold is checked. If it is determined the threshold has been met, the customers are notified the bottle of wine will be uncorked in Step S100. In Step S102 wine is uncorked and served to the customers. If it is determined the threshold has not been met in Step S96, the customers are notified of the status in Step S98. The customer has either the option of entering his/her payment information as he/she makes the request for wine or the customer can pay when he/she receives the wine at the establishment.

In accordance with another embodiment of the invention, customer requests may be canceled. The cancellation of requests occurs either when the customer himself/herself cancels the request or when the waiting period for the requested wine expires. FIG. 9 is a flow chart of the process in which a request is canceled. In Step S104 it is determined whether the customer request expired due to time constraints. If it is determined in Step S104 the time has not expired, it is then determined if the customer canceled the request in Step S106. A customer has the ability according to one embodiment, to cancel his/her request at any point before the wine has been uncorked. If it is determined the customer request has been canceled in Step S106, the system continues to accept and accumulate requests to attempt to satisfy the threshold. If it is determined in Step S106 the customer request is canceled, or the time constraints have expired in Step S104, the customer request is removed in Step S110.

In Step S112, the accumulated results are reduced. In Step S114, the display is updated with the results from Step S112. After the display has been updated in Step S114, the customer can optionally be notified of the canceled request in Step S116. The customers, while in the establishment, can be notified over a loud speaker, by cell phone, pager, display or other mobile device. The mobile devices can either be a personal device or one provided by the establishment. If the customers are not yet at the establishment they can be either emailed or called. If the customers are notified in Step S116, the system checks for additional canceled requests in Step S118. If it is determined additional requests are canceled in Step S118, the procedure starts again with Step S110.

Customers also have the option of bring his/her own bottle of wine to the establishment. Currently, most establishments require special arrangements in advance for one to provide his/her own wine. The current invention will allow customers bring in their own bottle of wine to sell glasses or tastes from their bottle. The restaurant could receive all, or some of the profit per glass or taste of wine. The management of the select establishment will have to authorize the arrangement.

Also optionally available to the customer is a bulletin board on the terminal or accessible through remote location connection. The bulletin board includes special promotions from either the establishment or a vendor. The promotions can include a reduced price, free wine or other items. The customer bringing his/her own wine to sell could therefore include his/her select wine in a list of specials on the bulletin board. The establishment may also award additional glasses, tastes or bottles of wine by offering a raffle or other special bonus, for example, reducing the price or giving the wine away. The raffle or bonus could be done to reduce inventory or to finish an uncorked bottle of wine.

A database of customers can optionally be included in the system. The database of customers allows customers to be contacted by the establishments. The database can contain specific wines the customer likes or other particulars. The customers can be asked if they want to add a request to an uncorked wine, or corked wine. The establishment could notify the customers of promotions, raffles, bonuses, or the status of a particular wine of interest. Hopefully, contacting the customers in advance will bring the additional customers to the establishment.

The present invention optionally allows for the establishment to determine whether the cost for a taste or glass wine is a flat fee, or if the price should be sensitive to how long the bottle has been uncorked. The variable price can be applied to customers who request wine after the threshold has been met and the reduced price may act as an incentive to buy the uncorked wine.

FIG. 13 is an illustration of the main processing unit 40 for implementing the computer processing in accordance with a computer-implemented embodiment of the present invention. The procedures described above may be presented in terms of program procedures executed on for example, a computer network of computer. The system may alternatively be done partially manually, and/or completely manually, thereby partially or completely eliminating the need for a computer.

Viewed externally in FIG. 13, the computer system 40 includes a central processing unit 42 having disk drives 44 and 46. Disk drives 44 and 46 are merely symbolic of the number of drives which might be accommodated by the computer system. Typically, the drives include a CD ROM drive 46, a hard drive (not shown externally) and floppy disk drive indicated by slot 44. The number and types of drives typically varies with different computer configurations. Disk drives 44 and 46 are in fact optional, and for space, may easily be omitted from the computer system in conjunction with the apparatus described herein.

The computer also has an optional display 48 upon which information is displayed. In some situations, a keyboard 50 and a mouse 52 may be provided as input devices to interface with the central processing unit 42. Then again, for enhanced portability, the keyboard 50 may be either a limited function keyboard or omitted in its entirety. In addition, mouse 52 may be a touch pad control device, or a track ball device, or even omitted in its entirety as well.

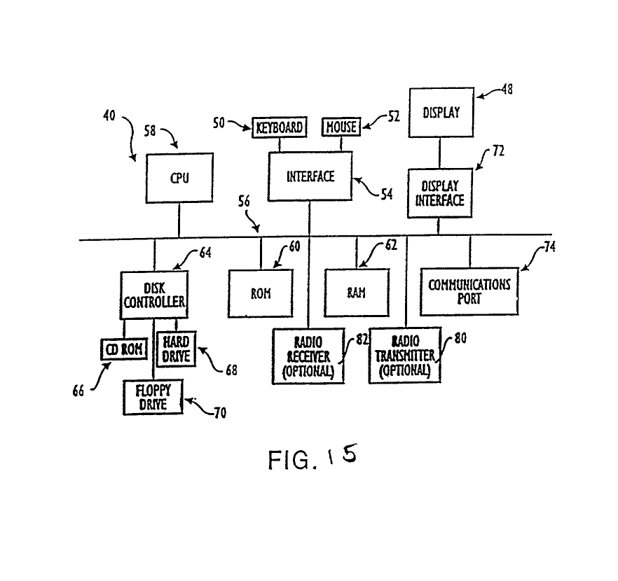

FIG. 14 is a block diagram of the internal hardware of the computer 40 illustrated in FIG. 13. The data bus 56 serves as the main information highway interconnecting the other components of the computer system. Central processing units (CPU) 58 is the central processing unit of the system performing calculations and logic operations required to execute a program. Read-only memory 60 and random access memory 62 constitute the main memory of the computer.

Disk controller 64 interfaces one or more disk drives to the system bus 56. These disk drives may be floppy disk drives such as 70, internal or external hard drives such as 68, or a CD ROM or DVD (digital video disks) drives such as 66. A display interface interfaces 72 with display and permits information from the bus 70 to be displayed on the display 72. Communications with the external devices can occur on communications port 74.

A display interface 72 interfaces display 48 and permits information from the bus 56 to be displayed on the display 48. Again as indicated, display 48 is also an optional accessory. For example, display 48 could be submitted or omitted. Communication with external devices, for example, the components of the apparatus described herein, occurs utilizing communication port 74. For example, optical fiber and/or electrical cables and/or conductors and/or optical communication (e.g., inferred, and the like) and/or wireless communications (e.g., radio frequency (RF), and the like) can be used as the transport medium between the external devices and the communication port 74.

In addition to the standard components of the computer, the computer also optionally includes at least one of infrared transmitter 76 or infrared receiver 78. Infrared transmitter 76 is utilized when the computer system is used in conjunction with one or more of the processing components/stations that transmits/receives data via infrared signal transmission.

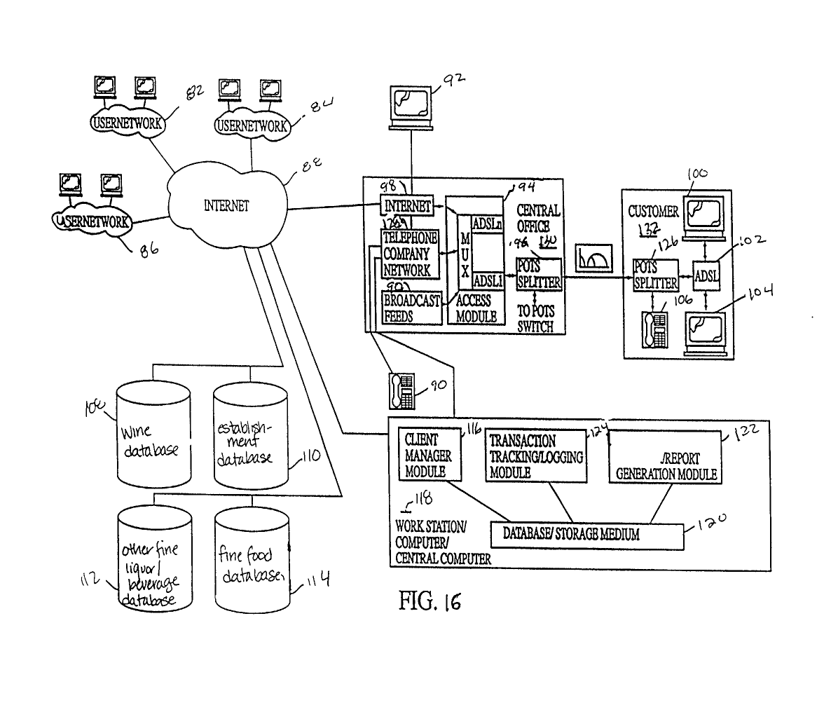

FIG. 15 is a block diagram of the internal hardware of the computer in FIG. 13. In addition to the standard components of the computer, the computer system may optionally use at least one of a low power radio transmitter 80 and/or a low power radio receiver 82. The low power transmitter 80 transmits the signal for reception and receives signals from the components via the low power radio receiver 82. The low power receiver 82 and low power transmitter 80 are standard.

FIG. 16 is an illustration of the architecture of the combined internet, POTS, and DSL architecture of the present invention in accordance with another embodiment. In FIG. 16, to preserve POTS and to prevent a fault in the ADSL equipment 102, 94 from compromising analog voice traffic 106, 90 the voice part of the spectrum (the lowest 4 kHZ) is optionally separated from the rest by a passive filter, called a POTS splitter 126, 96. The rest of the available bandwidth—from about 10 kHz to 1 MHz—carries data at rates up to 6 bits per second for every hertz of bandwidth from data equipment 104, 100, 92. The ADSL equipment 94 then has access to a number of destinations including significantly the Internet 98, and other destinations 90, 128.

To exploit the higher frequencies, ADSL makes use of advanced modulation techniques, of which the best known is the discrete multitone (DMT) technology. As its name implies, ADSL transmits data asymmetrically—at different rates upstream toward the central office 130 and downstream toward the subscriber 132.

Cable television providers are providing analogous Internet service to PC users over their TV cable systems by means of special cable modems. Such modems are capable of transmitting up to 30 Mb/s over hybrid fiber/coax systems, which use fiber to bring signals to a neighborhood and coax to distribute it to individual subscribers.

Cable modems come in many forms. Most create a downstream data stream out of one of the 6-MHz TV channels that occupy spectrum above 50 MHz (and more likely 550 MHz) and carve an upstream channel out of the 5-50-MHz band, which is currently unused. Using 64-state quadrature amplitude modulation (64 QAM), a downstream channel can realistically transmit about 30 Mb/s (the oft-quoted lower speed of 10 Mb/s refers to PC rates associated with Ethernet connections). Upstream rates differ considerably from vendor to vendor, but good hybrid fiber/coax systems can deliver upstream speeds of a few megabits per second. Thus, like ADSL, cable modems transmit much more information downstream than upstream.

The internet architecture 88 and ADSL architecture 102, 94 may also be combined with, for example, user networks 84, 82, and 86. As illustrated in this embodiment, users may access or use or participate in the administration, management computer assisted program in computer 240 via various different access methods. In this embodiment, the various databases 108, 110, 112, 114 and/or 120 are accessible via access to and/or by computer system 118, and/or via internet/local area network 88.

In accordance with this embodiment, workstation 118 includes modules 116, 124, and 116 for tracking/logging, reporting and managing the different requests. Alternatively, one module or a different number of modules may be used for processing the requests or interactions. The above embodiments are only to be construed as examples of the various different types of computer systems that may be utilized in connection with the computer assisted and/or implemented process for wine sharing.

The many features and advantages of the invention are apparent from the detailed specification, and thus, it is intended by the claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A computer system for sharing bottles of wine for customers desiring a taste or glass of wine, comprising:
a database storing first information including corked, uncorked wines and available amount of wine in each such bottle, and at least one threshold for uncorking at least one bottle of wine determined by the establishment;
at least one data entry device within an establishment that allows the customer to enter a request for the glass or taste of the wine;
at least one optional communications device which the establishment accesses to monitor and verify wine requests; and
a data processor, operatively connected to said database, said at least one data entry device, and said optional communications device, said data processor receiving the request, and at least one of determining whether the at least one threshold has been met to uncork the at least one bottle, and determining whether an already uncorked bottle will satisfy the request.

2. The computer system according to claim 1, wherein said database provides a bulletin board for promotions offered either by at least one of a vendor, said establishment, and other persons.

3. The computer system according to claim 1, wherein said database can be accessed from a remote location via at least one of wireless device, a global network and a local network.

4. The computer system according to claim 1, wherein said database accumulates additional requests when entered by said customers.

5. The computer system according to claim 4, wherein said data entry device wireless device, a global network and a local network are dynamically updated with the new requests as they are made.

6. The computer system according to claim 5, wherein at least one of said data entry device, wireless device, global network and local network displays visually the requests as the requests are incremented or decremented for a particular wine.

7. The computer system according to claim 1, wherein said customer can request the wine from said database prior to entering the establishment.

8. The computer system according to claim 1, further including a database of customers accessible by said data processor.

9. The computer system according to claim 8, wherein said database of customers is used to identify and notify customers in advance of available wines and existing requests.

10. The computer system according to claim 1, wherein said data entry device comprise a wireless device.

11. The computer system according to claim 1, wherein said database stores date and time the bottle of wine was uncorked to be used when additional wine remains in the bottle for other requests for the glass or taste of the wine.

12. The computer system according to claim 11, wherein said database stores the price per glass or taste of wine which may be at least one of fixed and variable with respect to the length of the time the bottle has been uncorked responsive to the date and the time the bottle of wine was uncorked stored in the database.

13. A computer system for sharing bottles of wine for customers desiring a taste or glass of wine, comprising:
a database storing first information including corked, uncorked wines and available amount of wine in each such bottle;
at least one optional communications device which the establishment accesses to monitor available amount of wine in uncorked bottles and corked bottles; and
a data processor, operatively connected to said database, said at least one data entry device, and said optional communications device, said data processor receiving the data on served wine and determining whether an uncorked bottle will satisfy a customer request.

14. The computer system according to claim 13, wherein said database stores date and time the bottle of wine was uncorked to be used when additional wine remains in the bottle for other requests for the glass or taste of the wine.

15. The computer system according to claim 14, wherein said database stores the price per glass or taste of wine which may be at least one of fixed and variable with respect to the length of the time the bottle has been uncorked responsive to the date and the time the bottle of wine was uncorked stored in the database.

16. A computer-implemented method of sharing at least one bottle of wine, comprising of the steps:
(a) requesting, by a customer, a request including at least one of a glass, taste or bottle of wine;
(b) optionally entering, by the customer, payment information;
(c) optionally verifying, by an establishment, the request with the customer;
(d) determining by an establishment, if a request threshold has been met indicative of a predetermined amount of the bottle of wine being request by at least one customer;
(e) uncorking and serving the at least one bottle of wine once the threshold has been met to the at least one customer;
(f) if the threshold has not been met, notifying customer of the request status.

17. The method according to claim 16, further comprising, the step of requesting by the customer multiple wine requests per order.

18. The method according to claim 16, further comprising, the step of requesting by the customer mutually exclusive wine requests.

19. The method according to claim 16, further comprising, the step of requesting by the customer from multiple establishments.

20. The method according to claim 16, further comprising, the step of requesting by the customer a waiting period for the threshold to be met.

21. The method according to claim 16, further comprising the step of altering, by the establishment, the customer when said requested wine is uncorked via a remote communication device.

22. The method according to claim 16, further comprising, the step of requesting by the customer wine from a remote location via email or another remote communication method.

23. The method according to claim 16, further comprising the steps of dynamically updating the terminal display with wine requests.

24. A computer system for sharing an item for customers desiring a portion of the item, comprising:
a database storing first information including characteristics regarding the item;
at least one optional communications device which the establishment accesses to monitor; and
a data processor, operatively connected to said database, said at least one data entry device, and said optional communications device, said data processor receiving the data on the item and determining whether the item will satisfy a customer request in accordance with predetermined criteria including satisfying a predetermined threshold associated with a plurality of requests from a plurality of users to share the item, and notifying the users when the predetermined threshold has been satisfied for sharing the item.

25. A computer system for sharing items for customers desiring to share an item, comprising:
a database storing first information including the at least one of the items, and at least one predetermined threshold for sharing the item;
at least one data entry device that allows the customer to enter a request for the item to be shared;
at least one optional communications device providing an establishment accesses to monitor and verify item requests; and
a data processor, operatively connected to said database, said at least one data entry device, and said optional communications device, said data processor receiving the request, and at least one of determining whether the at least one threshold has been met to share the item, and determining whether an existing available item will satisfy the request.

26. The computer system according to claim 25, wherein said database stores date and time the item was opened/prepared to be used when additional portions of the item remains for other requests for the item.

27. The computer system according to claim 26, wherein said database stores the price per portion of the item which may be at least one of fixed and variable with respect to the length of the time the item has been available responsive to the date and the time the item was opened/prepared stored in the database.

28. A computer-implemented method of sharing at least one bottle of wine, comprising of the steps:
(a) requesting at least one of a glass, taste or bottle of wine;
(b) optionally entering payment information;
(c) optionally verifying the request;
(d) aggregating the request with other requests for the at least one of a glass, taste or bottle of wine;
(e) determining if a request threshold has been met indicative of a predetermined amount of the bottle of wine being requested responsive to said step (d);
(f) if the request threshold has been met, uncorking and serving the at least one bottle of wine;
(g) if the request threshold has not been met, saving the request with the other request in accordance with first predetermined criteria and notifying customers associated with the request and the other requests in connection therewith;
(h) if the request threshold has not been met, displaying, to the customers and other customers via at least one of a display located in an establishment and wireless devices associated with the customers, status associated with aggregation of the requests and the request thresholds indicating a number of additional requests needed to reach the request threshold; and
(i) if the request threshold has not been met, maintaining the availability of the at least one of the glass, taste or bottle of wine in accordance with second predetermined criteria or until the request threshold has been met via receipt of additional requests for the at least one of the glass, taste or bottle of wine.

29. A computer system for sharing bottles of wine for customers desiring a taste or glass of wine, comprising:
means for storing first information including corked, uncorked wines and available amount of wine in each such bottle, and at least one threshold for uncorking at least one bottle of wine determined by the establishment;
means for allowing the customer to enter a request for the glass or taste of the wine;
at least one optional means for accessing via the establishment and for monitoring and verifying wine requests; and
means for receiving the request, and for at least one of determining whether the at least one threshold has been met to uncork the at least one bottle, and determining whether an already uncorked bottle will satisfy the request.
